(19) United States
(12) Patent Application Publication
(10) Pub. No.: US 2024/0176344 A1
(43) Pub. Date: May 30, 2024

(54) MONITORING PLAN GENERATION DEVICE, UNMANNED AERIAL VEHICLE MONITORING SYSTEM, AND MONITORING PLAN GENERATION METHOD

(71) Applicant: Rakuten Group, Inc., Tokyo (JP)

(72) Inventors: Asaki MATSUMOTO, Tokyo (JP); Takayoshi INUMA, Tokyo (JP); Shingo KAJIWARA, Tokyo (JP)

(73) Assignee: Rakuten Group, Inc., Tokyo (JP)

(21) Appl. No.: 18/508,832

(22) Filed: Nov. 14, 2023

(30) Foreign Application Priority Data
Nov. 29, 2022 (JP) 2022-190524

(51) Int. Cl. G05D 1/00

(52) U.S. Cl. CPC G05D 1/0033; G05D 1/0094

(57) ABSTRACT

The monitoring task management server MS acquires the monitoring schedule including the time zone in which the operator OPn can perform the monitoring task, acquires the monitoring required timing of the UAVm, and generates the monitoring plan of the UAVm on the basis of the monitoring schedule of the operator OPn and the monitoring required timing of the UAVm.

### CROSS REFERENCE TO RELATED APPLICATION

This application claims priority from Japanese Patent Application No. 2022-190524 which was filed on Nov. 29, 2022, the disclosure of which is herein incorporated by reference in its entirety.

### TECHNICAL FIELD

One or more embodiments of the present invention relates to a technical field such as a system for monitoring an unmanned aerial vehicle used for delivery of an article.

### RELATED ART

Conventionally, for example, as disclosed in JP 2022-529507 A, there is known a technique in which a plurality of operators arranged at a place away from an unmanned aerial vehicle monitor and control a plurality of flying unmanned aerial vehicles via a computing device. According to the technique disclosed in JP 2022-529507 A, it is possible to monitor and control a large number of unmanned aerial vehicles by one operator.

Meanwhile, it is undesirable for one operator to simultaneously monitor a plurality of unmanned aerial vehicles from the viewpoint of safety and the like. In the future, when articles are delivered from a plurality of bases by a plurality of unmanned aerial vehicles, there is a problem in that a monitoring task of the unmanned aerial vehicle by the operator increases. However, it is not preferable to increase the number of operators from the viewpoint of costs and the like. Therefore, it is desirable to appropriately perform the monitoring task by as few operators as possible.

Therefore, one or more embodiments of the present invention are to providing a monitoring plan generation device, an unmanned aerial vehicle monitoring system, and a monitoring plan generation method capable of causing an operator to appropriately perform a monitoring task to be performed at a monitoring required timing.

### SUMMARY

(An aspect 1) In response to the above issue, a monitoring plan generation device includes: at least one memory configured to store program code; and at least one processor configured to access the program code and operate as instructed by the program code. The program code includes: first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task; second acquisition code configured to cause the at least one processor to acquire a monitoring required timing at which the unmanned aerial vehicle needs to be monitored; and generation code configured to cause the at least one processor to generate a monitoring plan of the unmanned aerial vehicle on the basis of the monitoring schedule and the monitoring required timing.

(An aspect 2) The generation code may be further configured to cause the at least one processor to generate the monitoring plan by allocating the monitoring task to be performed at the monitoring required timing to the time zone in which the operator can perform the monitoring task in the monitoring schedule of the operator.

(An aspect 3) The first acquisition code may be further configured to cause the at least one processor to acquire the monitoring schedule of each of a plurality of the operators. The second acquisition code may be further configured to cause the at least one processor to acquire a plurality of the monitoring required timings. The generation code may be further configured to cause the at least one processor to generate, on the basis of a plurality of the monitoring schedules and the plurality of monitoring required timings, the monitoring plan by allocating the monitoring task to be performed at each of the plurality of monitoring required timings to the time zone in which any one of the plurality of operators can perform the monitoring task in any one of the plurality of monitoring schedules.

(An aspect 4) The operator may include a first operator and a second operator. The first acquisition code may be further configured to cause the at least one processor to acquire the monitoring schedule of the first operator and the monitoring schedule of the second operator. The monitoring required timing may include a first monitoring required timing and a second monitoring required timing. The generation code may be further configured to cause the at least one processor to generate the monitoring plan by (i) allocating the monitoring task to be performed at the first monitoring required timing to the time zone in which the first operator can perform the monitoring task in the monitoring schedule of the first operator, and by (ii) allocating the monitoring task to be performed at the second monitoring required timing to the time zone in which the second operator can perform the monitoring task in the monitoring schedule of the second operator.

(An aspect 5) The operator may include a first operator and a second operator. The first acquisition code may be further configured to cause the at least one processor to acquire the monitoring schedule of the first operator and the monitoring schedule of the second operator. The unmanned aerial vehicle may include a first unmanned aerial vehicle and a second unmanned aerial vehicle. The second acquisition code may be further configured to cause the at least one processor to acquire the monitoring required timing of the first unmanned aerial vehicle and the monitoring required timing of the second unmanned aerial vehicle. The monitoring task may include a monitoring task of a first task type and a monitoring task of a second task type. The generation code may be further configured to cause the at least one processor to generate the monitoring plan by (i) allocating, to the time zone in which the first operator can perform the monitoring task in the monitoring schedule of the first operator, the monitoring task of the first task type to be performed at the monitoring required timing of the first unmanned aerial vehicle and the monitoring task of the first task type to be performed at the monitoring required timing of the second unmanned aerial vehicle, and by (ii) allocating, to the time zone in which the second operator can perform the monitoring task in the monitoring schedule of the second operator, the monitoring task of the second task type to be performed at the monitoring required timing of the first unmanned aerial vehicle and the monitoring task of the second task type to be performed at the monitoring required timing of the second unmanned aerial vehicle.

(An aspect 6) The unmanned aerial vehicle may include a first unmanned aerial vehicle and a second unmanned aerial vehicle. The monitoring schedule of a first operator among a plurality of the operators may have a monitoring task allocated thereto and configured to monitor the first unmanned aerial vehicle and a monitoring task allocated thereto and configured to monitor the second unmanned aerial vehicle. The program code further may include delay control code configured to cause the at least one processor to delay, when a delay occurs in a delivery schedule of the first unmanned aerial vehicle, the monitoring required timing of the first unmanned aerial vehicle. The generation code may be further configured to cause the at least one processor to change, in a case where at least a part of the monitoring required timing after the delay of the first unmanned aerial vehicle and at least a part of the monitoring required timing of the second unmanned aerial vehicle overlap with each other, the monitoring plan by allocating the monitoring task to be performed at the monitoring required timing of the second unmanned aerial vehicle to the time zone in which the monitoring task can be performed in the monitoring schedule of a second operator other than the first operator.

(An aspect 7) The monitoring schedule may have a monitoring task already allocated thereto and configured to monitor another unmanned aerial vehicle deployed in a base different from a base of the unmanned aerial vehicle.

(An aspect 8) The program code further may include transmission code configured to cause the at least one processor to transmit, to a terminal used by the operator, information for causing the operator to perform the monitoring task to be performed at the monitoring required timing in response to arrival of the monitoring required timing.

(An aspect 9) The monitoring required timing may be at least one of a plurality of timings separated by time in a delivery schedule related to one delivery by the unmanned aerial vehicle.

(An aspect 10) An unmanned aerial vehicle monitoring system includes: at least one memory configured to store program code; and at least one processor configured to access the program code and operate as instructed by the program code. The program code include: first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task; second acquisition code configured to cause the at least one processor to acquire a monitoring required timing at which the unmanned aerial vehicle needs to be monitored; and generation code configured to cause the at least one processor to generate a monitoring plan of the unmanned aerial vehicle on the basis of the monitoring schedule and the monitoring required timing.

(An aspect 11) A monitoring plan generation method executed by a computer includes: acquiring a monitoring schedule of an operator who performs a monitoring task for monitoring an unmanned aerial vehicle used for delivering an article, the monitoring schedule including a time zone in which the operator can perform the monitoring task; acquiring a monitoring required timing at which the unmanned aerial vehicle needs to be monitored; and generating a monitoring plan of the unmanned aerial vehicle on the basis of the monitoring schedule and the monitoring required timing.

### BRIEF DESCRIPTION OF THE DRAWINGS

FIG. 1 is a diagram illustrating a schematic configuration example of a delivery management system S.

FIG. 2 is a conceptual diagram illustrating a state in which a UAV1 delivers an item to a delivery destination.

FIG. 3 is a diagram illustrating a schematic configuration example of a monitoring task management server MS.

FIG. 4 is a diagram illustrating an example of a monitoring required timing calculation table.

FIG. 5 is a diagram illustrating examples of contents of a monitoring plan management database 126.

FIG. 6 is a diagram illustrating functional block examples in a control unit 13.

FIG. 7 is a conceptual diagram illustrating a temporal relationship between monitoring schedules SC1 and SC2 of operators O1 and O2 and monitoring required timing groups TG1 to TG3.

FIG. 8 is a diagram illustrating an example of the contents of the monitoring plan management database 126 in a case where a operator OPn who performs a monitoring task is fixed for each task type.

FIG. 9 is a diagram illustrating an example of a deliverable time selection screen displayed on an orderer terminal UT.

FIG. 10 is a diagram illustrating an example of a monitoring task performance screen displayed on an operator terminal OT1.

FIG. 11 is a conceptual diagram illustrating an example in which a monitoring task to be performed at a monitoring required timing of an UAV2 is replaced from a monitoring schedule of an operator OP1 to a monitoring schedule of an operator OP4.

FIG. 12 is a flowchart illustrating an example of monitoring plan determination processing of the control unit 13 in the monitoring task management server MS.

FIG. 13 is a flowchart illustrating an example of monitoring task information transmission processing of the control unit 13 in the monitoring task management server MS.

### DETAILED DESCRIPTION

Hereinbelow, one or more embodiments of the present invention will be described with reference to the drawings. The following embodiment is an embodiment in a case where the present invention is applied to a delivery management system that manages delivery of an article by an unmanned aerial vehicle (hereinafter, referred to as a “UAV (unmanned aerial vehicle)”) such as a drone. The UAV is an example of an unmanned flying object. Incidentally, in the following embodiment, a description will be given, as an example, as to a case in which an item (an example of an article) sold (provided) at a store is ordered from a terminal (hereinafter, referred to as an “orderer terminal”) used by an orderer (an example of a delivery requester) to an order processing server, and the item is delivered to a delivery destination.

### [1. Configuration and Operation Outline of Delivery Management System S]

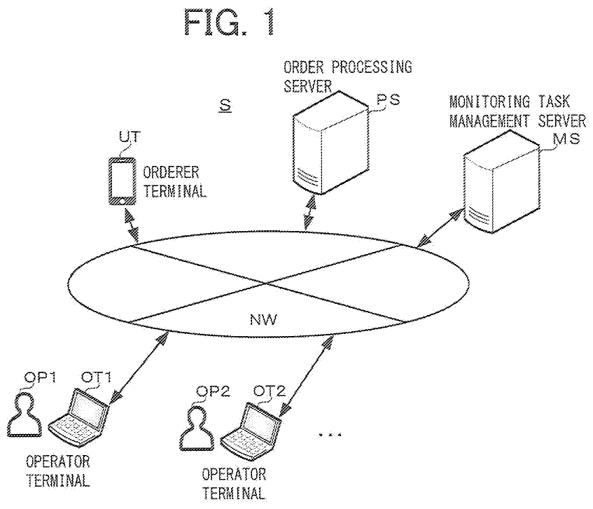

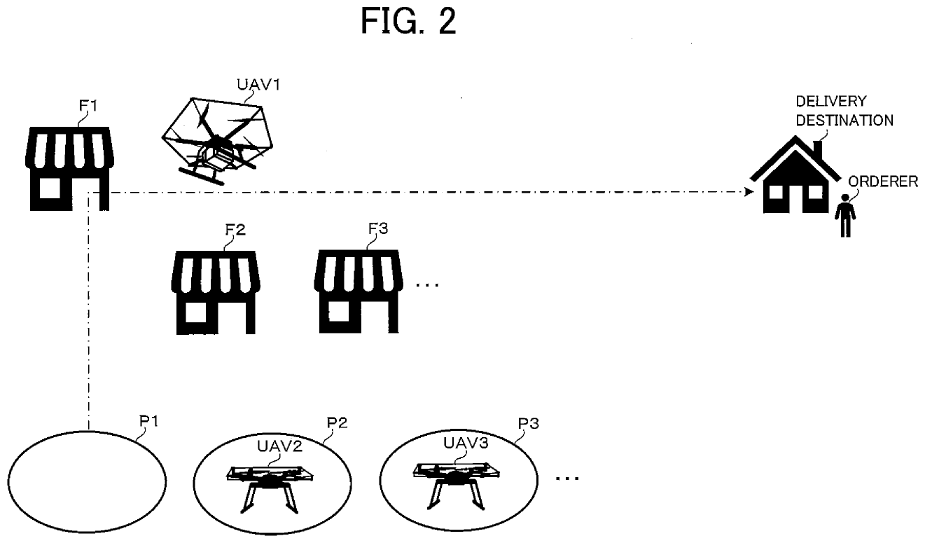

First, a description will be given as to a configuration and an operation outline of a delivery management system S according to the present embodiment with reference to FIGS. 1 and 2. FIG. 1 is a diagram illustrating a schematic configuration example of the delivery management system S. As illustrated in FIG. 1, the delivery management system S includes an order processing server PS, a monitoring task management server MS, a plurality of operator terminals OTn (n=1, 2, . . . ), and the like. Here, the monitoring task management server MS is an example of a monitoring plan generation device. The monitoring task management server MS and the plurality of operator terminals OTn can form an unmanned aerial vehicle monitoring system of the present invention. Moreover, the monitoring task management server MS may be formed to be integrated with the order processing server PS. The operator terminal OTn is used by an operator OPn (n=1, 2 . . . ). For example, an operator terminal OT1 is used by an operator OP1 (an example of a first operator), and an operator terminal OT2 is used by an operator OP2 (an example of a second operator). The order processing server PS, the monitoring task management server MS, and the operator terminal OTn are connected to a communication network NW. The communication network NW includes, for example, the Internet, a mobile communication network and a radio base station thereof, and the like.

FIG. 2 is a conceptual diagram illustrating a state in which a UAV1 delivers an item to a delivery destination. In the example of FIG. 2, a plurality of UAVms (m=1, 2, 3 . . . ) used for delivery of items are respectively deployed in different bases Pm (m=1, 2, 3 . . . ). Among the plurality of UAVm, an UAV1 is an example of a first UAV, and an UAV2 is an example of a second UAV. Since an item (e.g., product, merchandise, goods, or commodity) is sold at a store Fo (o=1, 2, 3 . . . ), the UAVm flies to the store Fo from the base Pm to pick up the item. For example, as illustrated in FIG. 2, after the order of an item is confirmed, the UAV1 flies from the base P1 to the store F1 that sells the item, loads the item in the store F1, and flies to a delivery destination. Incidentally, a plurality of UAVms may be deployed in one base Pm. For example, the UAV1 and the UAV2 may be deployed in the base P1. Moreover, the base Pm and the store Fo may be in the same place. For example, the store F1 may be installed in the base P1. In this case, the UAV1 may not fly from the base P1 to the store F1.

The order processing server PS is a server that receives and processes an order from an orderer terminal UT (for example, a mobile terminal such as a smartphone) that has accessed via the communication network NW, and transmits information on the received order to the monitoring task management server MS. Here, the information on the order includes, for example, an order ID (identification information on the order), a user ID of an orderer (identification information on the orderer), an item ID of an item ordered by the orderer (identification information on the item), an item name, a store ID of a store that sells the item (identification information on the store Fo), position information of a delivery destination (for example, latitude and longitude), and the like. Incidentally, information on the item (for example, an item name and a photographic image of the item) is selectably (in a selectable manner) presented to the orderer from the order processing server PS (that is, the information is displayed on the orderer terminal UT).

Moreover, the order processing server PS selectably presents, to the orderer, a deliverable time (for example, a plurality of different deliverable times) of the item (that is, the deliverable time or the deliverable time frame is displayed on the orderer terminal UT). The deliverable time is provided from the monitoring task management server MS. The order of the item is confirmed when any deliverable time is selected by the orderer from the deliverable time presented to the orderer. Here, the deliverable time is a time zone in which the item can be reached to the delivery destination. In other words, the deliverable time is a scheduled time zone in which the UAVm loaded with the item arrives at the delivery destination. Alternatively, the deliverable time may be a scheduled time zone in which the UAVm arriving at the delivery destination lands on the ground or the like and a recipient can receive the item from the UAVm. Incidentally, the deliverable time may be a time (for example, 12:00), but is desirably a time zone (for example, from 12:00 to 12:15) in consideration of a certain margin.

The monitoring task management server MS is a server that manages information on a monitoring task for monitoring the UAVm used for delivery of the item. The monitoring task can be referred to as, for example, operation (work) of monitoring the state of the UAVm and the peripheral situation of the UAVm. The monitoring task is performed by the operator OPn via the operator terminal OTn at a monitoring required timing at which the UAVm is required to be monitored (the monitoring required timing of the UAVm). The monitoring task may include a terminal operation (that is, the operation of the operator terminal OTn) for performing flight control (for example, movement control and hovering control) of the UAVm depending on the situation. Moreover, the monitoring task is allocated to a time zone in which the monitoring task can be performed in the monitoring schedule of the operator OPn.

In the present embodiment, for example, a scene is assumed in which the operator OP1 in a monitoring base performs a monitoring task for each of the plurality of UAVms that respectively perform delivery at different bases Pm. In order to perform safe delivery, information on the UAVm is displayed on the operator terminal OT1 used by the operator OP1 at a timing when a monitoring task by the operator OP1 is necessary, such as when each UAVm arrives above the store Fo or when each UAVm lands. For example, even if the UAV1 that has left the base P1 arrives above the store F1, in a case where the delivery preparation of the UAV2 is completed in the store F2 at the same timing and the operator OP1 is performing the monitoring task, the monitoring task for the UAV1 cannot be performed.

Incidentally, the monitoring in this embodiment includes the gaze of the operator OPn through vision (looks carefully). Therefore, the monitoring required timing can also be referred to as gaze (gaze required) timing. Moreover, the monitoring required timing is desirably a plurality of timings (an example of a first monitoring required timing and a second monitoring required timing) separated by time in the delivery schedule related to one delivery by the UAVm to be monitored. As a result, in the delivery schedule related to one delivery, it is possible to cause the operator OPn to efficiently perform the monitoring task to be performed at the monitoring required timing of the UAVm. However, the monitoring required timing may be one timing in the delivery schedule related to one delivery by the UAVm to be monitored. Here, the timing may be a time point (in other words, time) or a time zone (that is, a certain time width may be provided). A delivery schedule is, for example, a schedule until the UAVm takes off from the base Pm and lands at the delivery destination via the store Fo (alternatively, until the UAVm takes off from the delivery destination).

Moreover, the monitoring task management server MS regularly or irregularly receives UAV information on the UAVm from the UAVm via the communication network NW. Here, the UAV information includes, for example, a position, a state, a battery remaining amount, and the like detected by various sensors of the UAVm. Moreover, the UAV information may include a UAV video captured by a UAVm camera. The UAV video may include, for example, an obstacle that may obstruct take-off and landing of the UAVm. Moreover, the monitoring task management server MS may regularly or irregularly receive UAV peripheral information on the peripheral situation of the UAVm from various sensors installed in the store Fo or the base Pm via the communication network NW. Moreover, the UAV peripheral information includes a wind direction, a wind speed, and a rainfall amount detected by a weather sensor installed in the store Fo or the base Pm. The UAV peripheral information may include a peripheral video of the UAVm captured by a camera installed in the store Fo or the base Pm. The peripheral video may include, for example, an obstacle that may obstruct take-off and landing of the UAVm. Moreover, the monitoring task management server MS may regularly or irregularly receive the weather of an area where the UAVm is located as the UAV peripheral information from a weather management server via the communication network NW.

### [1-1. Configuration and Function of Monitoring Task Management Server MS]

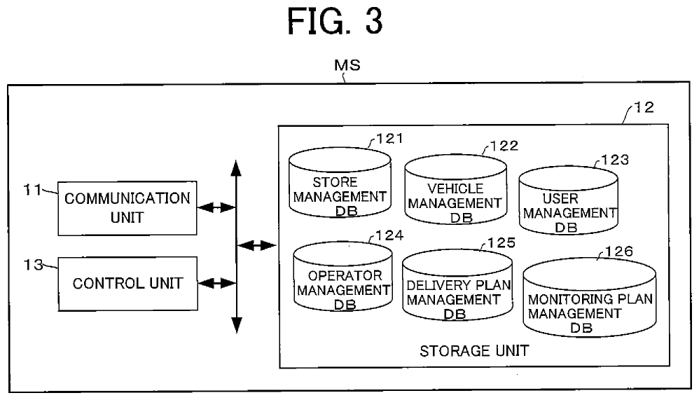

Next, a configuration and a function of the monitoring task management server MS will be described with reference to FIG. 3. FIG. 3 is a diagram illustrating a schematic configuration example of the monitoring task management server MS. As illustrated in FIG. 3, the monitoring task management server MS includes a communication unit 11, a storage unit 12, a control unit 13, and the like. The communication unit 11 controls communication performed via the communication network NW. The communication unit 11 receives information on the order from the order processing server PS. Moreover, the communication unit 11 receives at least one of the UAV information and the UAV peripheral information from the UAVm or the like. The storage unit 12 includes, for example, a hard disk drive or the like, and stores an operating system, various programs including an application, and the like. Here, the application includes a program for performing a monitoring plan generation method. Moreover, the storage unit 12 includes a buffer memory that sequentially updates and accumulates at least one of the UAV information and the UAV peripheral information received from the UAVm in association with a vehicle ID of the UAVm (identification information of the UAVm) for each UAVm.

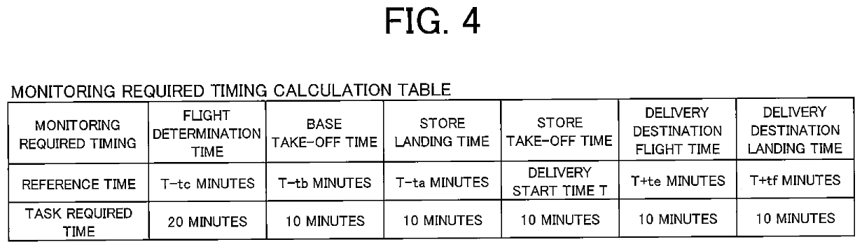

Moreover, the storage unit 12 stores a monitoring required timing calculation table. FIG. 4 is a diagram illustrating an example of the monitoring required timing calculation table. As illustrated in FIG. 4, a monitoring required timing, a reference time, and a task required time are registered in association with each other in the monitoring required timing calculation table. Here, the reference time is a time for calculating the monitoring required timing associated with the reference time. The task required time is a time length required to perform the monitoring task at the monitoring required timing associated with the task required time. In the example of FIG. 4, as examples of the monitoring required timing, a flight determination time (operating decision time), a base take-off time, a store landing time, a store take-off time, a delivery destination flight time, and a delivery destination landing time are shown (six). Here, the “time” may be “immediately before”. The task types of the monitoring tasks to be performed at the respective monitoring required timings are different from each other. Incidentally, the number of task types may be smaller or larger than the number (six) shown in FIG. 4. Moreover, in a case where the base Pm and the store Fo are at the same place, the base take-off time, the store landing time, and the store take-off time can be combined into the store take-off time.

Here, the store take-off time indicates, for example, a timing at which the UAVm loaded with an item takes off from the store Fo for delivery (this is also referred to as “delivery start”). This timing is set to a delivery start time T (a time point) or a time zone on the basis of the delivery start time T by referring to the reference time associated with this timing. The length of the time zone may be equal to the task required time required for performing the monitoring task at the monitoring required timing (the same applies to other monitoring required timings). Incidentally, in the monitoring required timing calculation table, since the delivery start time T becomes a reference, it is registered as, for example, “0:00”. The store landing time indicates, for example, a timing at which the UAVm taking off from the base Pm arrives above the store and lands (for example, landing on the rack of the store Fo). This timing is set to a time point before “ta” minutes (for example, 10 minutes) from the delivery start time T or a time zone on the basis of the time point by referring to the reference time associated with this timing.

The base take-off time indicates, for example, a timing at which the UAVm takes off from the base Pm. This timing is set to a time point before “tb” minutes from the delivery start time T or a time zone on the basis of the time point by referring to the reference time associated with this timing. The “tb” minutes are the sum of the “ta” minutes and the required time of “tx” minutes from the base Pm to the store Fo. The required time of “tx” minutes is calculated from a flight distance from the base Pm to the store Fo and a flight speed (scheduled speed) of the UAVm. The flight determination time indicates a timing at which it is determined whether the UAVm can be in flight. This timing is set to a time point before “tc” minutes from the delivery start time T or a time zone on the basis of the time point by referring to the reference time associated with this timing. The “tc” minutes are the sum of the “tb” minutes and a margin time of “ty” minutes including the time required for the flight determination.

The delivery destination flight time indicates, for example, a timing at which the UAVm taking off from the store Fo reaches a halfway delivery position. This timing is set to a time point after “te” minutes from the delivery start time T or a time zone on the basis of the time point by referring to the reference time associated with this timing. The minutes “te” are the required time (flight duration) from the store Fo to the halfway delivery position, and are calculated from the flight distance from the store Fo to the halfway delivery position and the flight speed of the UAVm. Incidentally, the halfway delivery position is a position of a predetermined ratio (for example, 50%) of the flight path from the store Fo to the delivery destination. The delivery destination landing time indicates, for example, a timing at which the UAVm taking off from the store Fo arrives above the delivery destination and lands at the delivery destination. This timing is set to a time point after “tf” minutes from the delivery start time T or a time zone on the basis of the time point by referring to the reference time associated with this timing. The “tf” minutes are the required time (flight duration) from the store Fo to the delivery destination, and are calculated from the flight distance from the store Fo to the delivery destination and the flight speed of the UAVm. The time point after the “tf” minutes from the delivery start time T corresponds to (for example, is consistent with or included in) the above-described deliverable time.

As described above, the monitoring tasks can be distinguished into a plurality of different task types (examples of a first task type and a second task type). For example, the monitoring task of the flight determination time, the monitoring task of the base take-off time, the monitoring task of the store landing time, the monitoring task of the store take-off time, the monitoring task of the delivery destination flight time, and the monitoring task of the delivery destination landing time are different from each other in task type. However, even in the case of monitoring tasks having different task types, the contents (for example, what to gaze at) of the monitoring tasks may be the same or different from each other.

Furthermore, in the storage unit 12, a store management database (DB) 121, a vehicle management database (DB) 122, a user management database (DB) 123, an operator management database (DB) 124, a delivery plan management database (DB) 125, a monitoring plan management database (DB) 126, and the like are constructed. The store management database 121 is a database for managing information on the store Fo that sells an item. In the store management database 121, for example, a store ID, position information (for example, latitude and longitude) of the store Fo, and the like are stored (registered) in association with each store Fo.

The vehicle management database 122 is a database for managing information on the UAVm used for delivery of an item. In the vehicle management database 122, for example, a vehicle ID of the UAVm, an operation situation, an available time zone, position information of the base Pm in which the UAVm is deployed, and the like are stored in association with each UAVm. The operation situation indicates an operating state (for example, moving for delivery preparation, using for delivery, returning), an unusable state, or a standby state, and is updated as appropriate. The available time zone indicates a date and time zone in which the UAVm can be used for delivery.

The user management database 123 is a database for managing information on a user, the account of which is created as a use member of a delivery service. Here, the user having the created account can order an item to the order processing server PS via the orderer terminal UT as an orderer. In the user management database 123, a user ID, a name, an address, an e-mail address, and a telephone number are stored in association with each user. Incidentally, in the user management database 123, an address or position information of a delivery destination of the item may be registered in advance.

The operator management database 124 is a database for managing information on the operator OPn. In the operator management database 124, for example, an operator ID (identification information of the operator OPn) of the operator OPn, a monitoring schedule of the operator OPn, access information (for example, an IP address) of the operator terminal OTn used by the operator OPn, and the like are stored in association with each operator OPn. The monitoring schedule of the operator OPn includes, for example, at least one of a time zone (date and time zone) in which the operator OPn can perform the monitoring task and a time zone (year, month, day, and time zone) in which the operator OPn cannot perform the monitoring task. The time zone in which the monitoring task is not performable includes, for example, a time zone to which a monitoring task for monitoring another UAVm is already allocated (that is, the time zone in which the monitoring task has already entered), a break time zone, and the like.

The delivery plan management database 125 is a database for managing information on a delivery plan. In the delivery plan management database 125, an order ID, a determined delivery plan, and the like are stored in association with each order (delivery). The delivery plan includes, for example, an item ID of an item to be delivered, a vehicle ID of the UAVm that delivers the item, a delivery schedule of the UAVm, and the like. The UAVm indicated in the delivery plan is the UAVm determined to be used for delivery. The delivery schedule includes a deliverable time, a delivery start time, and the like. Incidentally, one delivery corresponds to one order ID and one UAVm. For example, an item related to an order identified by the order ID of “d0001” is delivered by the UAV1, and an item related to an order identified by the order ID of “d0002” is delivered by the UAV2.

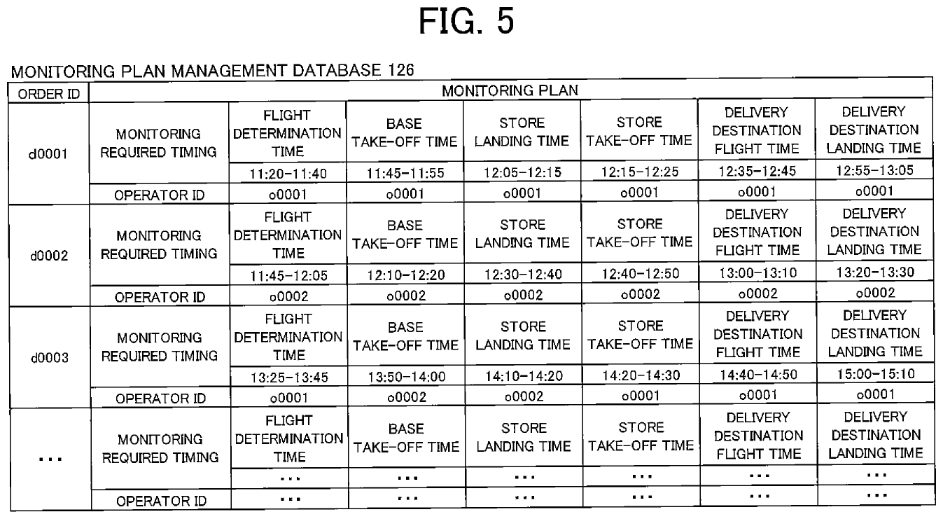

The monitoring plan management database 126 is a database for managing information on a monitoring plan. In the monitoring plan management database 126, an order ID, a determined monitoring plan, and the like are stored in association with each order. Here, the monitoring plan is a plan (in other words, the performance plan of the monitoring task) indicating which operator OPn performs the monitoring task for which UAVm at which monitoring required timing. FIG. 5 is a diagram illustrating examples of the contents of the monitoring plan management database 126. As illustrated in FIG. 5, in the monitoring plan associated with the order ID of “d0001”, the operator ID of the operator OPn who performs the monitoring task is associated with each task type. Moreover, in the monitoring plan, the vehicle ID of the UAVm (the UAVm to be monitored) that requires monitoring at the monitoring required timing may be associated with the operator ID. Incidentally, in the examples of FIG. 5, the monitoring required timing is represented by a time zone (for convenience, date is omitted), and the monitoring task is performed in this time zone (the time zone related to the monitoring required timing).

The control unit 13 includes at least one CPU (Central Processing Unit), a ROM (Read Only Memory), a RAM (Random Access Memory), and the like. The CPU (an example of processor) is configured to access the program code stored in the ROM or the storage unit 12 and operate as instructed by the program code. The program code includes: first acquisition code configured to cause the CPU to acquire the monitoring schedule of the operator OPn who performs the monitoring task for monitoring the UAVm used for delivering the article; second acquisition code configured to cause the CPU to acquire the monitoring required timing at which the UAVm needs to be monitored; and generation code configured to cause the CPU to generate the monitoring plan of the UAVm on the basis of the monitoring schedule and the monitoring required timing. The program code may include delay control code configured to cause the CPU to delay, when a delay occurs in a delivery schedule of the UAV 1, the monitoring required timing of the UAV 1. Moreover, the program code further may include transmission code configured to cause the CPU to transmit, to the operator terminal OTn, information for causing the operator OPn to perform the monitoring task to be performed at the monitoring required timing in response to arrival of the monitoring required timing.

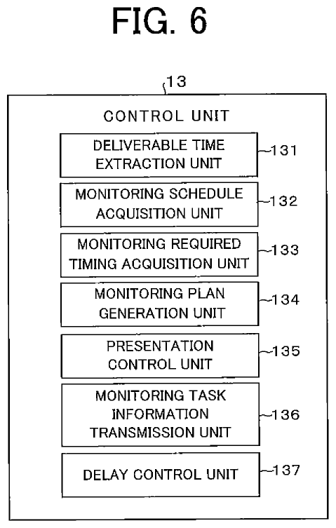

FIG. 6 is a diagram illustrating functional block examples in the control unit 13. As illustrated in FIG. 6, the control unit 13 functions as, for example, a deliverable time extraction unit 131, a monitoring schedule acquisition unit 132, a monitoring required timing acquisition unit 133, a monitoring plan generation unit 134, a presentation control unit 135, a monitoring task information transmission unit 136, a delay control unit 137, and the like in accordance with a program (a program code group) stored in the ROM or the storage unit 12.

For example, when information on an order is received, the deliverable time extraction unit 131 extracts a predetermined number (for example, three or more) of deliverable times of an item related to the order on the basis of an estimated time required for delivery of the item related to the order or the like. Here, the estimated time required for the delivery of the item is estimated from a preparation time for picking up and loading the item and a required time for the UAVm to reach a delivery destination. The required time is calculated from, for example, a flight distance identified from position information on the base Pm in which the UAVm waits, position information of the store Fo, and position information of the delivery destination, and a flight speed of the UAVm. Incidentally, in extracting the deliverable time, the available time zone or the like of the UAVm managed in the vehicle management database 122 may be appropriately referred to.

Examples of a plurality of extracted deliverable times include “12:00 (a starting point) to 12:15 (an ending point)”, “12:15 to 12:30”, “12:30 to 12:45”, “12:45 to 13:00”, “13:00 to 13:15”, . . . , and the like. The time zones related to the respective plurality of deliverable times may partially overlap with each other. In this case, the plurality of deliverable times are extracted, for example, such as “12:00 to 12:15”, “12:10 to 12:25”, and “12:20 to 12:35”. In this example, the length of the time zone is 15 minutes, but is not particularly limited. Incidentally, the extracted deliverable time is associated with the order ID and the UAVm (the vehicle ID) capable of delivering the item to the delivery destination at the deliverable time.

For example, when information on the order is received, the monitoring schedule acquisition unit 132 acquires a monitoring schedule of each of the plurality of operators On from the operator management database 124. The monitoring required timing acquisition unit 133 acquires a monitoring required timing at which monitoring of the UAVm is required. For example, the monitoring required timing acquisition unit 133 acquires each monitoring required timing (a plurality of monitoring required timings) at which it is required to monitor the UAVm associated with a deliverable time on the basis of the deliverable time extracted by the deliverable time extraction unit 131 and the monitoring required timing calculation table stored in the storage unit 12. Hereinafter, each monitoring required timing in one delivery is also referred to as a “monitoring required timing group”.

More specifically, the delivery start time T (for example, 11:20) is calculated from a starting point (for example, 12:00) of the deliverable time extracted by the deliverable time extraction unit 131 and a required time (for example, 40 minutes) from the store Fo to the delivery destination (that is, inverse calculation is performed). The calculated delivery start time T is associated with the order ID and the deliverable time. Then, the calculated delivery start time T is applied to the monitoring required timing calculation table, whereby the monitoring required timing group is acquired. For example, the delivery start time T″ in the monitoring required timing calculation table illustrated in FIG. 4 is set to 11:20 (in other words, update from the default 0:00 to 11:20), and each reference time is identified, whereby the monitoring required timing group is calculated. Incidentally, in a case where a plurality of deliverable times are extracted by the deliverable time extraction unit 131, the monitoring required timing group corresponding to each deliverable time is acquired.

The monitoring plan generation unit 134 generates the monitoring plan for the UAVm associated with the deliverable time on the basis of the monitoring schedule acquired by the monitoring schedule acquisition unit 132 and the monitoring required timing (for example, the monitoring required timing group) acquired by the monitoring required timing acquisition unit 133. For example, the monitoring plan generation unit 134 generates the monitoring plan by allocating the monitoring task to be performed at each of the monitoring required timings in the monitoring required timing group of the UAV1, for example, to a time zone in which any one operator OP1 out of the plurality of operators O1 and O2 can perform the monitoring task in any one of the plurality of monitoring schedules on the basis of the monitoring schedule (that is, a plurality of monitoring schedules) of each of the operators O1 and O2 and the monitoring required timing group corresponding to the deliverable time. As a result, it is possible to cause one operator OP1 (the operator ID of “00001”) to more efficiently perform the monitoring task to be performed at each of the monitoring required timings in the monitoring required timing group of one UAV1 in one go (a single pass) (for example, refer to the order ID of “d0001” illustrated in FIG. 5).

As described above, the processing of generating the monitoring plan is performed for each deliverable time extracted by the deliverable time extraction unit 131. Then, in a case where the monitoring plan is generated, the monitoring plan is associated with the order ID and the deliverable time. Incidentally, for example, in the monitoring schedule of the operator OP1, for example, a monitoring task for monitoring another UAV2 deployed in the base P2 different from the base P1 of the UAV1 may be already allocated. As a result, it is possible to cause one operator OP1 to efficiently perform the monitoring task to be performed at the monitoring required timing of the UAVm deployed at each of the plurality of bases Pm.

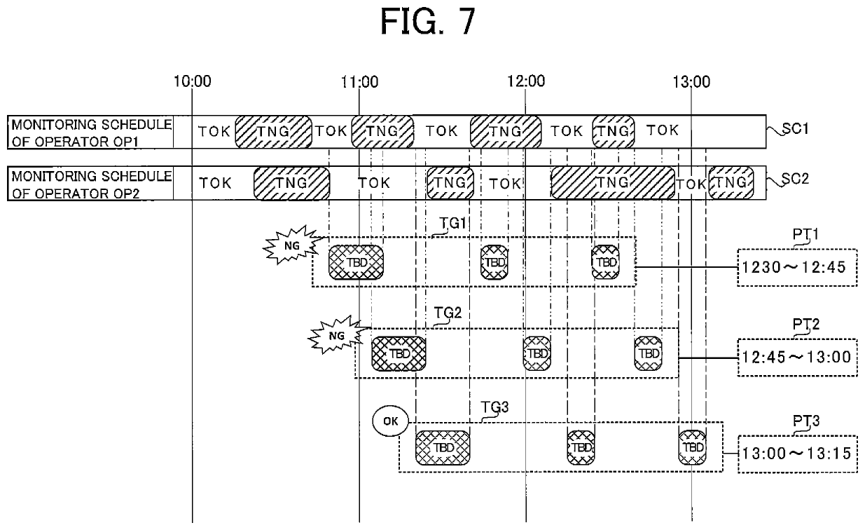

FIG. 7 is a conceptual diagram illustrating a temporal relationship between monitoring schedules SC1 and SC2 of the operators O1 and O2 and monitoring required timing groups TG1 to TG3. The monitoring required timing groups TG1 to TG3 correspond to deliverable times PT1 to PT3, respectively. Incidentally, for convenience of description, each of the monitoring required timing groups TG1 to TG3 includes three monitoring required timings TBD (for example, the flight determination time, the store take-off time, and the delivery destination landing time). Moreover, in each of the monitoring schedules SC1 and SC2, a time zone TOK in which each of the operators O1 and O2 can perform the monitoring task and a time zone TNG in which each of the operators O1 and O2 cannot perform the monitoring task are illustrated. In this example, the monitoring task to be performed at each of the three monitoring required timings TBD in the monitoring required timing group TG3 is allocated to the time zone TOK in which the operator OP1 can perform the monitoring task. As a result, the monitoring plan corresponding to the deliverable time PT3 is generated.

Incidentally, in FIG. 7, at least one of the three monitoring required timings TBD in the monitoring required timing group TG1 corresponding to the deliverable time PT1 partially overlaps with the time zone TNG in which the operator OP1 cannot perform the monitoring task. Similarly, at least one of the three monitoring required timings TBD in the monitoring required timing group TG1 partially overlaps with the time zone TNG in which the operator OP2 cannot perform the monitoring task. Therefore, the monitoring plan corresponding to the deliverable time PT1 is not generated. On the other hand, in a case where there is a deliverable time in which the monitoring task to be performed at each monitoring required timing TBD can be allocated to the time zone TOK in which the monitoring task can be performed other than the deliverable time PT1 among the deliverable times extracted by the deliverable time extraction unit 131, the monitoring plan corresponding to the deliverable time is also generated. That is, one order may generate the monitoring plan corresponding to each of the plurality of deliverable times. In this case, the monitoring plan corresponding to one deliverable time selected by the orderer is determined.

As another example, the monitoring plan generation unit 134 may generate the monitoring plan by allocating the monitoring task to be performed at the first monitoring required timing in the monitoring required timing group to the time zone in which the operator OP1 can perform the monitoring task in the monitoring schedule of the operator OP1, and by allocating the monitoring task to be performed at the second monitoring required timing in the monitoring required timing group to the time zone in which the operator OP2 can perform the monitoring task in the monitoring schedule of the operator OP2. As a result, the performance burden of the monitoring task to be performed at each monitoring required timing in the monitoring required timing group of one UAVm can be distributed to a plurality of operators On. In this case, in FIG. 7, the monitoring task to be performed at one (in the example of FIG. 7, the right TBD) of the three monitoring required timings TBD in the monitoring required timing group TG2 corresponding to the deliverable time PT2 is allocated to the time zone TOK in which the operator OP1 can perform the monitoring task, and the monitoring tasks to be performed at the remaining two (in the example of FIG. 7, the left and center TBDs) are allocated to the time zone TOK in which the operator OP2 can perform the monitoring task. As a result, the monitoring plan corresponding to the deliverable time PT2 is generated.

Alternatively, as another example, the operator OPn who performs the monitoring task may be fixed for each task type (that is, complete division of work for each task type). As a result, the monitoring task to be performed at the monitoring required timing of each of the plurality of UAVms can be divided into the plurality of operators On for each task type. Therefore, the expertise of the monitoring task for each task type can be enhanced, thereby making it possible to allow the operator OPn to more appropriately perform the monitoring task. In this case, for example, the monitoring plan generation unit 134 generates the monitoring plan by (i) allocating the monitoring task (for example, the monitoring task of the store landing time) of the first task type to be performed at the monitoring required timing of the UAV1 and the monitoring task of the first task type to be performed at the monitoring required timing of the UAV2 to the time zone in which the operator OP1 can perform the monitoring task in the monitoring schedule of the operator OP1, and by (ii) allocating the monitoring task (for example, the monitoring task of the store take-off time) of the second task type to be performed at the monitoring required timing of the UAV1 and the monitoring task of the second task type to be performed at the monitoring required timing of the UAV2 to the time zone in which the operator OP2 can perform the monitoring task in the monitoring schedule of the operator OP2.

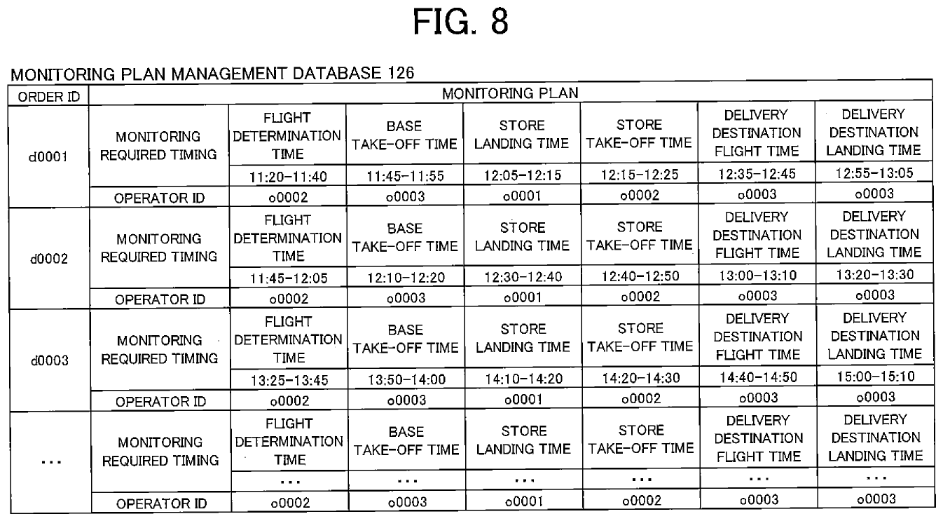

FIG. 8 is a diagram illustrating an example of the contents of the monitoring plan management database 126 in a case where the operator OPn who performs the monitoring task is fixed for each task type. In the example of FIG. 8, the monitoring task of the store landing time is allocated so as to be performed by the operator OP1 (the operator ID of “00001”). Moreover, the monitoring task of the flight determination time and the monitoring task of the store take-off time are allocated so as to be performed by the operator OP2 (the operator ID of “00002”). The monitoring task of the base take-off time, the monitoring task of the delivery destination flight time, and the monitoring task of the delivery destination landing time are allocated so as to be performed by an operator OP3 (the operator ID of “00003”).

The presentation control unit 135 performs control to selectably present, to an orderer of an item, the deliverable time of the item by the UAVm (that is, the deliverable time is displayed on the orderer terminal UT of the orderer). Such presentation of the deliverable time is performed by allowing the order processing server PS to transmit information indicating the deliverable time provided by the presentation control unit 135 to the orderer terminal UT. At this time, the presentation control unit 135 performs control such that the orderer cannot select some deliverable time among the deliverable times on the basis of the monitoring schedule and the monitoring required timing described above. As a result, it is possible to appropriately prevent the operator OPn from becoming incapable of performing the monitoring task. Moreover, it is possible to limit the deliverable time that can be selected by the orderer according to the monitoring schedule of the operator OPn and the monitoring required timing of the UAVm. Therefore, it is possible to cause the operator OPn to appropriately perform the monitoring task to be performed at the monitoring required timing at which the UAVm needs to be monitored.

For example, the presentation control unit 135 performs control so as not to include the some deliverable time in the information provided to the order processing server PS. Alternatively, the presentation control unit 135 may perform control so as to allow the information to be provided to the order processing server PS to include the some deliverable time and information indicating that the deliverable time cannot be selected. Incidentally, the presentation control unit 135 may perform control so as to allow the information indicating the deliverable time to be directly transmitted from the monitoring task management server MS to the orderer terminal UT without passing through the order processing server PS. Here, said “some deliverable time” is, for example, the deliverable time corresponding to the monitoring required timing (for example, the monitoring required timing group) at which the operator OPn (for example, all of the plurality of operators On) becomes incapable of performing the monitoring task among the plurality of deliverable times extracted by the deliverable time extraction unit 131. As a result, it is possible to present, to the orderer, the deliverable time corresponding to the monitoring required timing as long as it is the monitoring required timing at which even one of the plurality of operators On can perform the monitoring task. Therefore, it is possible to cause the operator OPn to efficiently perform the monitoring task to be performed at the monitoring required timing of the UAVm.

Incidentally, apart from the monitoring plan generation processing by the monitoring plan generation unit 134, the presentation control unit 135 may perform allocation processing of allocating the monitoring task to be performed at each of the monitoring required timings in the monitoring required timing group to the time zone in which the operator OPn can perform the monitoring task on the basis of the monitoring schedule of the operator OPn and the monitoring required timing group corresponding to the extracted deliverable time. Such allocation processing is performed for each of the plurality of extracted deliverable times. Then, the presentation control unit 135 identifies, on the basis of a result of the allocation processing, the deliverable time corresponding to the monitoring required timing at which the operator OPn becomes incapable of performing the monitoring task among the plurality of extracted deliverable times as the some deliverable time. As a result, it is possible to quickly identify the deliverable time that limits the presentation to the orderer.

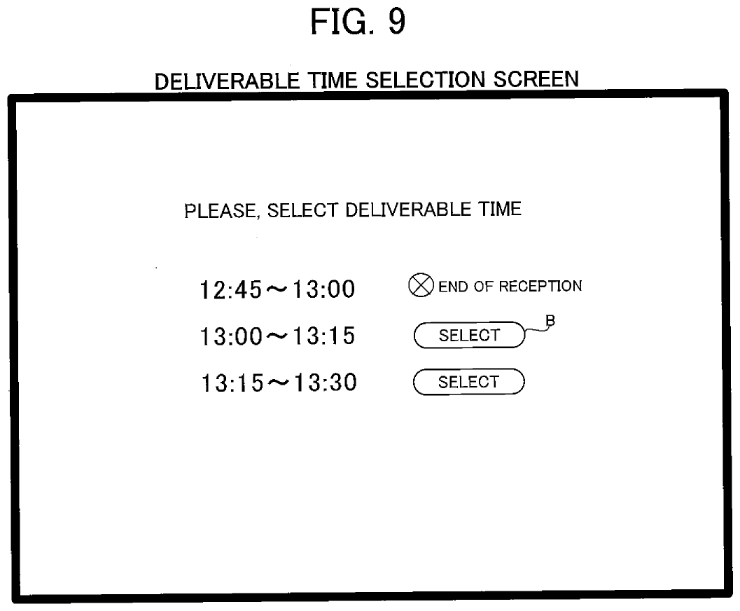

FIG. 9 is a diagram illustrating an example of a deliverable time selection screen displayed on the orderer terminal UT. On the deliverable time selection screen illustrated in FIG. 9, as the deliverable time, “12:45 to 13:00”, “13:00 to 13:15”, and “13:15 to 13:30” are displayed. Among the displayed deliverable times, “13:00 to 13:15” and “13:15 to 13:30” are presented deliverable times in a selectable manner. For example, when the orderer designates a button B indicating “select” associated with “13:00 to 13:15”, the display content of the button B changes to “selecting”. Then, information (for example, the order ID is included) indicating the selected deliverable time is transmitted from the orderer terminal UT to the monitoring task management server MS via the order processing server PS. As a result, the monitoring plan corresponding to the selected deliverable time is determined, and the delivery plan related to the order is determined. Incidentally, in the example of FIG. 9, the some deliverable time is not displayed on the deliverable time selection screen, but the some deliverable time may be displayed on the deliverable time selection screen, and the display content of the button indicating “select” may be grayed out so as to prevent selection of the some deliverable time.

The monitoring task information transmission unit 136 transmits (for example, push delivery) information (hereinafter, referred to as “monitoring task information”) for causing the operator OPn to perform the monitoring task to be performed at the monitoring required timing to the operator terminal OTn used by the operator OPn according to the arrival of the monitoring required timing of the UAVm to be monitored. As a result, it is possible to cause the operator OPn to quickly and appropriately perform the monitoring task to be performed at the monitoring required timing of the UAVm. Incidentally, “According to the arrival of the monitoring required timing” means a case in which the current time becomes a starting point of the time zone related to the monitoring required timing or a case in which the current time becomes several seconds before the starting point. The monitoring task information may include a message prompting the operator OPn to perform the monitoring task. Such a message may include information indicating the contents of the monitoring task. Moreover, the monitoring task information may include a control command for causing the operator terminal OTn to display (for example, pop-up) a monitoring task performance screen.

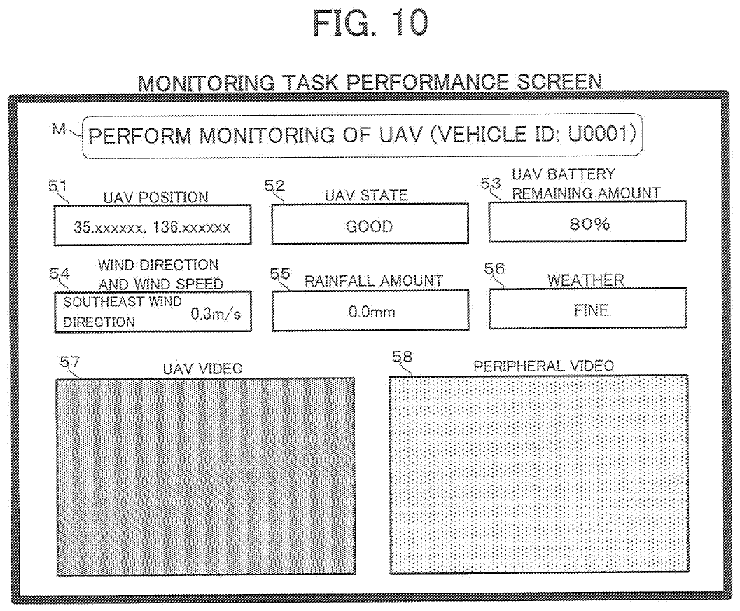

FIG. 10 is a diagram illustrating an example of the monitoring task performance screen displayed on the operator terminal OT1. On the monitoring task performance screen illustrated in FIG. 10, UAV information on the UAV1 to be monitored and UAV peripheral information on the peripheral situation of the UAV1 are displayed, and a message M prompting the operator OP1 to perform the monitoring task is displayed. The UAV information and the UAV peripheral information are sequentially received from the monitoring task management server MS. As illustrated in FIG. 10, the position of the UAV1 is displayed in a UAV position display area 51. In a UAV state display area 52, the state of the UAV1 is displayed. The remaining battery amount of the UAV1 is displayed in a UAV battery display area 53. Incidentally, a monitoring task performance screen different for each task type may be displayed.

In a wind direction and wind speed display area 54, a wind direction and a wind speed detected by a weather sensor installed in the store Fo or the base P1 where the UAV1 is located are displayed. In a rainfall amount display area 55, a rainfall amount detected by the weather sensor installed in the store Fo or the base P1 where the UAV1 is located is displayed. A weather display area 56 displays the weather of the area where the UAV1 is located. In a UAV camera video display area 57, a UAV video captured by a camera of the UAV1 is displayed. In a peripheral camera video display area 58, a peripheral video of the UAV1 captured by a camera installed in the store Fo or the base P1 where the UAV1 is located is displayed. The operator OP1 performs the monitoring task while viewing the information displayed on the monitoring task performance screen.

Meanwhile, in a case where a delay occurs in a delivery schedule due to, for example, the state of the UAV1, the peripheral situation, or the like in which the delivery schedule is determined, the delay control unit 137 delays the monitoring required timing of the UAV1. That is, the delay control unit 137 updates (changes) the monitoring required timing of the UAV1 in the monitoring plan registered in the monitoring plan management database 126 so as to delay the monitoring required timing of the UAV1 according to the delay time of the delivery schedule of the UAV1. Further, the delay control unit 137 updates (changes) the time zone to which the monitoring task is allocated in the monitoring schedule of the operator OP1 who performs the monitoring task at the changed monitoring required timing so as to delay the time zone according to the delay time of the delivery schedule of the UAV1.

In a case where the monitoring required timing of the UAV1 is delayed in this manner, in a case where a monitoring task for monitoring the UAV2, for example, other than the UAV1 is allocated to the monitoring schedule of the operator OP1, the delay control unit 137 determines whether at least a part of the monitoring required timing after the delay of the UAV1 and at least a part of the monitoring required timing of the UAV2 overlap with each other. Then, in a case where at least a part of the monitoring required timing after the delay of the UAV1 and at least a part of the monitoring required timing of the UAV2 overlap with each other, the delay control unit 137 changes the monitoring plan by allocating the monitoring task to be performed at the monitoring required timing of the UAV2 to the time zone in which the monitoring task can be performed in the monitoring schedule of another operator OPn other than the operator OP1. That is, the monitoring task to be performed at the monitoring required timing of the UAV2 is replaced (i.e., shifted) from the operator OP1 to another operator OPn (that is, the monitoring schedule of the operator OPn). As a result, even in a case where at least a part of the monitoring required timing after the delay of the UAV1 and at least a part of the monitoring required timing of the UAV2 overlap with each other due to occurrence of the delay in the delivery schedule of the UAV1, the monitoring task to be performed at the monitoring required timing of each of the UAV1 and the UAV2 can be appropriately performed by the operator OP1 and another operator OPn.

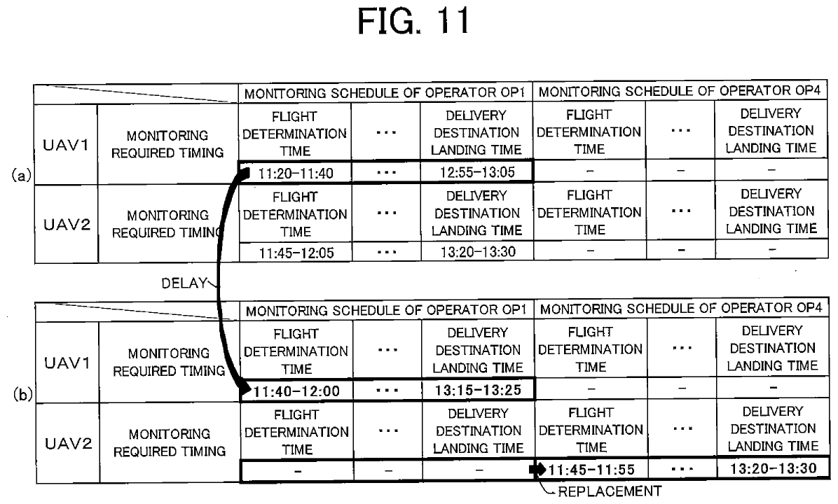

FIG. 11 is a conceptual diagram illustrating an example in which the monitoring task to be performed at the monitoring required timing of the UAV2 is replaced from the monitoring schedule of the operator OP1 to a monitoring schedule of an operator OP4. In the example of FIG. 11, when a delay occurs in the determined delivery schedule of the UAV1, the monitoring required timing “11:20 to 11:40” corresponding to the flight determination time is changed to “11:40 to 12:00”, and the monitoring required timing “12:55 to 13:05” corresponding to the delivery destination landing time is changed to “13:15 to 13:25”. Therefore, since at least a part of the monitoring required timing after the delay of the UAV1 and at least a part of the monitoring required timing of the UAV2 overlap with each other, the monitoring task to be performed at the monitoring required timing of the UAV2 is replaced (shifted) from the monitoring schedule of the operator OP1 to the monitoring schedule of the operator OP4.

Incidentally, in a case where there is no operator OPn who can replace the monitoring task to be performed at the monitoring required timing of the UAV2, the delay control unit 137 may notify the orderer of a message indicating delivery cancellation. The notification of such a message may be performed by transmitting an e-mail describing the message to the e-mail address of the orderer, or may be performed by transmitting the message to the phone number of the orderer by SMS. Alternatively, the notification of the message may be performed by pushing and delivering the message to a notification application resident in the orderer terminal UT of the orderer.

### [2. Operation of Delivery Management System S]

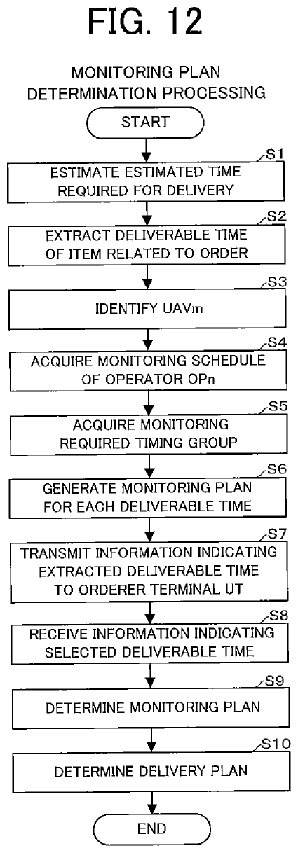

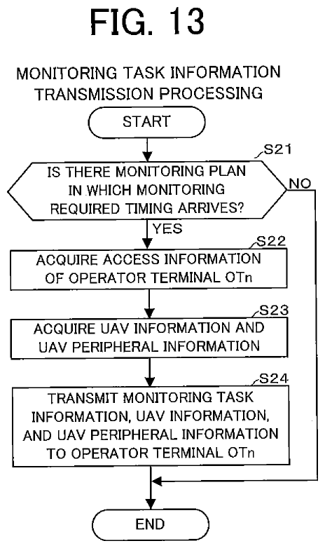

Next, the operation of the delivery management system S will be described with reference to FIGS. 12 to 13. FIG. 12 is a flowchart illustrating an example of monitoring plan determination processing of the control unit 13 in the monitoring task management server MS. FIG. 13 is a flowchart illustrating an example of monitoring task information transmission processing of the control unit 13 in the monitoring task management server MS.

### (2-1. Monitoring Plan Determination Processing)

First, as a premise of the processing illustrated in FIG. 12, it is assumed that an order from the orderer terminal UT is received by the order processing server PS. The processing illustrated in FIG. 12 is started, for example, when information on the order is received from the order processing server PS by the monitoring task management server MS.

When the processing illustrated in FIG. 12 is started, the control unit 13 estimates an estimated time required for the delivery of an item related to the order as described above on the basis of the received information on the order (step S1).

Next, the control unit 13 extracts a plurality of (for example, three) deliverable times of the item related to the order by the deliverable time extraction unit 131 as described above on the basis of the estimated time and the like estimated in step S1 (step S2).

Next, the control unit 13 refers to the vehicle management database 122 (that is, refer to the available time zone of each UAVm, and the like), and identifies one UAVm that can deliver the item to the delivery destination at the deliverable time for each deliverable time extracted in step S2 (step S3). The UAVm (the vehicle ID) accordingly identified is associated with the order ID included in the information on the order and the deliverable time extracted in step S2.

Next, the control unit 13 causes the monitoring schedule acquisition unit 132 to acquire the monitoring schedule of each of the plurality of operators On from the operator management database 124 (step S4). Next, on the basis of the deliverable time extracted in step S2 and the monitoring required timing calculation table stored in the storage unit 12, the control unit 13 causes the monitoring required timing acquisition unit 133 to acquire a monitoring required timing group configured to require monitoring of the UAVm associated with the deliverable time for each deliverable time as described above (step S5).

Next, on the basis of the monitoring schedule acquired in step S4 and the monitoring required timing group acquired in step S5, the control unit 13 causes the monitoring plan generation unit 134 to generate the monitoring plan of the UAVm associated with the deliverable time extracted in step S2 as described above (step S6). The monitoring plan accordingly generated is associated with the deliverable time. Incidentally, among the plurality of deliverable times extracted in step S2, there is also a deliverable time for which the monitoring plan is not generated.

Next, the control unit 13 causes the presentation control unit 135 to transmit information indicating the deliverable time extracted in step S2 to the orderer terminal UT of the orderer (step S7). As a result, the deliverable time is selectably displayed on the orderer terminal UT. That is, the deliverable time is presented to the orderer in a selectable manner. At this time, as described above, the presentation control unit 135 performs control such that the orderer cannot select the deliverable time (in other words, the deliverable time for which the monitoring plan is not generated) corresponding to the monitoring required timing at which the operator OPn becomes incapable of performing the monitoring task. Incidentally, the deliverable time displayed on the orderer terminal UT may be only the deliverable time at which the monitoring plan is generated, but is not limited thereto. For example, configuration may be adopted such that a simple timetable that is not related to the deliverable time is displayed on the orderer terminal UT, and only a portion corresponding to the deliverable time for which the monitoring plan is generated can be selected.

Then, when any one of the deliverable times displayed on the orderer terminal UT is selected by the orderer, information (for example, the order ID is included) indicating the selected deliverable time is transmitted from the orderer terminal UT to the monitoring task management server MS via the order processing server PS. Accordingly, the received order is confirmed.

Next, when receiving the information indicating the deliverable time selected by the orderer (step S8), the control unit 13 determines the monitoring plan associated with the selected deliverable time as the monitoring plan of the UAVm associated with the deliverable time (step S9). The monitoring plan accordingly determined is stored in the monitoring plan management database 126 in association with the order ID of the confirmed order. Next, the control unit 13 determines a delivery plan including the delivery schedule of the UAVm associated with the selected deliverable time (step S10), and ends the processing illustrated in FIG. 12. The delivery plan accordingly determined is stored in the delivery plan management database 125 in association with the order ID of the confirmed order.

### (2-2. Monitoring Task Information Transmission Processing)

Next, as a premise of the processing illustrated in FIG. 13, it is assumed to use a monitoring list for registering the monitoring plan including the monitoring required timing that arrives within a predetermined time (for example, 24 hours) from the current time among the monitoring plans stored in the monitoring plan management database 126. For example, the processing illustrated in FIG. 13 is started at a predetermined cycle (for example, intervals of a few seconds).

When the processing illustrated in FIG. 13 is started, the control unit 13 determines whether there is a monitoring plan in which the monitoring required timing arrives (for example, the starting point of the monitoring required timing has passed the current time) among the monitoring plans registered in the monitoring list (step S21). When it is determined that there is the monitoring plan in which the monitoring required timing has arrived (step S21: YES), the processing proceeds to step S22. On the other hand, when it is determined that there is no monitoring plan in which the monitoring required timing has arrived (step S21: NO), the processing ends.

In step S22, the control unit 13 acquires, for example, the access information of the operator terminal OT1 used by the operator OP1 associated with the monitoring required timing included in the monitoring plan in which the monitoring required timing has arrived, and the vehicle ID of the UAV1 that requires monitoring at the monitoring required timing. Next, the control unit 13 acquires UAV information and UAV peripheral information of the UAV1 identified by the vehicle ID acquired in step S22 from the buffer memory (step S23).

Next, the control unit 13 establishes an access to the operator terminal OT1 via the communication network NW according to the access information acquired in step S22, and transmits the above-described monitoring task information, and the UAV information and the UAV peripheral information acquired in step S23 to the operator terminal OT1 by the monitoring task information transmission unit 136 (step S24). Incidentally, while the access to the operator terminal OT1 is established, the control unit 13 performs control so as to sequentially transmit the UAV information of the UAV1 and the UAV peripheral information thereof to the operator terminal OT1.

Then, when receiving the monitoring task information, the UAV information, and the UAV peripheral information, the operator terminal OT1 displays, for example, the UAV information and the UAV peripheral information of the UAV1 on the monitoring task performance screen together with the message M prompting the operator OP1 to perform the monitoring task, as illustrated in FIG. 10. As a result, the operator OP1 performs the monitoring task for monitoring the UAV1.

As described above, according to the above-described embodiment, the monitoring task management server MS acquires the monitoring schedule including the time zone in which the operator OPn can perform the monitoring task, acquires the monitoring required timing of the UAVm, and generates the monitoring plan of the UAVm on the basis of the monitoring schedule of the operator OPn and the monitoring required timing of the UAVm. Therefore, it is possible to cause the operator OPn to appropriately perform the monitoring task to be performed at the monitoring required timing of the UAVm according to the generated monitoring plan.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above-described embodiment, a description has been given, as an example, as to a case in which an orderer orders an item to be sold at the store Fo, but the present invention is also applicable to a case in which an article other than the item is delivered. An example of such a case includes a case in which relief supplies or support supplies requested by a delivery requester are delivered to an evacuation place or the like. Moreover, in the above-described embodiment, the UAV has been described as an example of the unmanned aerial vehicle, but the present invention is also applicable to a flying robot or the like as an example of the unmanned aerial vehicle.

### REFERENCE SIGNS LIST

11 Communication unit
12 Storage unit
13 Control unit
131 Deliverable time extraction unit
132 Monitoring schedule acquisition unit
133 Monitoring required timing acquisition unit
134 Monitoring plan generation unit
135 Presentation control unit
136 Monitoring task information transmission unit
137 Delay control unit
PS Order processing server
MS Monitoring task management server
OTn Operator terminal
UT Orderer terminal
S Delivery management system
NW Communication network

What is claimed is:

1. A monitoring plan generation device comprising:
at least one memory configured to store program code; and at least one processor configured to access the program code and operate as instructed by the program code, the program code including:
first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task;
second acquisition code configured to cause the at least one processor to acquire a monitoring required timing at which the unmanned aerial vehicle needs to be monitored; and
generation code configured to cause the at least one processor to generate a monitoring plan of the unmanned aerial vehicle on the basis of the monitoring schedule and the monitoring required timing.

2. The monitoring plan generation device according to claim 1, wherein the generation code is further configured to cause the at least one processor to generate the monitoring plan by allocating the monitoring task to be performed at the monitoring required timing to the time zone in which the operator can perform the monitoring task in the monitoring schedule of the operator.

3. The monitoring plan generation device according to claim 1, wherein
the first acquisition code is further configured to cause the at least one processor to acquire the monitoring schedule of each of a plurality of the operators,
the second acquisition code is further configured to cause the at least one processor to acquire a plurality of the monitoring required timings, and
the generation code is further configured to cause the at least one processor to generate, on the basis of a plurality of the monitoring schedules and the plurality of monitoring required timings, the monitoring plan by allocating the monitoring task to be performed at each of the plurality of monitoring required timings to the time zone in which any one of the plurality of operators can perform the monitoring task in any one of the plurality of monitoring schedules.

4. The monitoring plan generation device according to claim 1, wherein
the operator includes a first operator and a second operator,
the first acquisition code is further configured to cause the at least one processor to acquire the monitoring schedule of the first operator and the monitoring schedule of the second operator,
the monitoring required timing includes a first monitoring required timing and a second monitoring required timing, and
the generation code is further configured to cause the at least one processor to generate the monitoring plan by (i) allocating the monitoring task to be performed at the first monitoring required timing to the time zone in which the first operator can perform the monitoring task in the monitoring schedule of the first operator, and by (ii) allocating the monitoring task to be performed at the second monitoring required timing to the time zone in which the second operator can perform the monitoring task in the monitoring schedule of the second operator.

5. The monitoring plan generation device according to claim 1, wherein
the operator includes a first operator and a second operator,
the first acquisition code is further configured to cause the at least one processor to acquire the monitoring schedule of the first operator and the monitoring schedule of the second operator,
the unmanned aerial vehicle includes a first unmanned aerial vehicle and a second unmanned aerial vehicle,
the second acquisition code is further configured to cause the at least one processor to acquire the monitoring required timing of the first unmanned aerial vehicle and the monitoring required timing of the second unmanned aerial vehicle,
the monitoring task includes a monitoring task of a first task type and a monitoring task of a second task type, and
the generation code is further configured to cause the at least one processor to generate the monitoring plan by (i) allocating, to the time zone in which the first operator can perform the monitoring task in the monitoring schedule of the first operator, the monitoring task of the first task type to be performed at the monitoring required timing of the first unmanned aerial vehicle and the monitoring task of the first task type to be performed at the monitoring required timing of the second unmanned aerial vehicle, and by (ii) allocating, to the time zone in which the second operator can perform the monitoring task in the monitoring schedule of the second operator, the monitoring task of the second task type to be performed at the monitoring required timing of the first unmanned aerial vehicle and the monitoring task of the second task type to be performed at the monitoring required timing of the second unmanned aerial vehicle.

6. The monitoring plan generation device according to claim 1, wherein
the unmanned aerial vehicle includes a first unmanned aerial vehicle and a second unmanned aerial vehicle,
the monitoring schedule of a first operator among a plurality of the operators has a monitoring task allocated thereto and configured to monitor the first unmanned aerial vehicle and a monitoring task allocated thereto and configured to monitor the second unmanned aerial vehicle,
the program code further including delay control code configured to cause the at least one processor to delay, when a delay occurs in a delivery schedule of the first unmanned aerial vehicle, the monitoring required timing of the first unmanned aerial vehicle, and
the generation code is further configured to cause the at least one processor to change, in a case where at least a part of the monitoring required timing after the delay of the first unmanned aerial vehicle and at least a part of the monitoring required timing of the second unmanned aerial vehicle overlap with each other, the monitoring plan by allocating the monitoring task to be performed at the monitoring required timing of the second unmanned aerial vehicle to the time zone in which the monitoring task can be performed in the monitoring schedule of a second operator other than the first operator.

7. The monitoring plan generation device according to claim 1, wherein the monitoring schedule has a monitoring task already allocated thereto and configured to monitor another unmanned aerial vehicle deployed in a base different from a base of the unmanned aerial vehicle.

8. The monitoring plan generation device according to claim 1, the program code further including transmission code configured to cause the at least one processor to transmit, to a terminal used by the operator, information for causing the operator to perform the monitoring task to be performed at the monitoring required timing in response to arrival of the monitoring required timing.

9. The monitoring plan generation device according to claim 1, wherein the monitoring required timing is at least one of a plurality of timings separated by time in a delivery schedule related to one delivery by the unmanned aerial vehicle.

10. An unmanned aerial vehicle monitoring system comprising:
at least one memory configured to store program code; and at least one processor configured to access the program code and operate as instructed by the program code, the program code including:
first acquisition code configured to cause the at least one processor to acquire a monitoring schedule of an operator who performs a monitoring task for monitoring an unmanned aerial vehicle used for delivering an article, the monitoring schedule including a time zone in which the operator can perform the monitoring task;
second acquisition code configured to cause the at least one processor to acquire a monitoring required timing at which the unmanned aerial vehicle needs to be monitored; and
generation code configured to cause the at least one processor to generate a monitoring plan of the unmanned aerial vehicle on the basis of the monitoring schedule and the monitoring required timing.

11. A monitoring plan generation method executed by a computer comprising:
acquiring a monitoring schedule of an operator who performs a monitoring task for monitoring an unmanned aerial vehicle used for delivering an article, the monitoring schedule including a time zone in which the operator can perform the monitoring task;
acquiring a monitoring required timing at which the unmanned aerial vehicle needs to be monitored; and
generating a monitoring plan of the unmanned aerial vehicle on the basis of the monitoring schedule and the monitoring required timing.
